(19) United States
(12) Patent Application Publication
(10) Pub. No.: US 2013/0211720 A1
(43) Pub. Date: Aug. 15, 2013

(54) Driver-assistance method and driver-assistance system for snow-covered roads

(71) Applicant: Volker Niemz, Rutesheim (DE)

(72) Inventor: Volker Niemz, Rutesheim (DE)

(21) Appl. No.: 13/762,669

(22) Filed: Feb. 8, 2013

(30) Foreign Application Priority Data
Feb. 9, 2012 (DE) 10 2012 201 896.4

(51) Int. Cl. G01C 21/20

(52) U.S. Cl. CPC G01C 21/20
USPC 701/538

(57) ABSTRACT

A driver-assistance method, in which an optical sensor records an environment of a vehicle, and ruts formed by the tracks of vehicles driving ahead are detected based on the acquired data, and a signal is output to the driver when leaving the ruts. Also described is a driver-assistance system for executing the method.

### RELATED APPLICATION INFORMATION

The present application claims priority to and the benefit of German patent application No. 10 2012 201 896.4, which was filed in Germany on Feb. 9, 2012, the disclosure of which is incorporated herein by reference.

### FIELD OF THE INVENTION

The present invention relates to a driver-assistance method and to a driver assistance system for snow-covered roads.

### BACKGROUND INFORMATION

Lane-following systems, hereinafter called lane-following assistants, are used especially when driving on expressways in order to assist the driver in staying in lane on longer stretches without significant traffic volume; however, they can also be used to advantage in city traffic. Lane-following assistants analyze information about the course of the traffic lane in which the vehicle is located and they output a signal to the driver, such as an acoustic signal, as soon as the vehicle appears to be straying from the lane, or they implement an automatic steering intervention. In addition, a graphical output may be made to the driver. Furthermore, lane-following assistants cooperate with vehicle steering systems, and in so doing, intervene—autonomously to a defined extent—in the drive train of the vehicle and/or in the control of the vehicle, for instance in order to prevent a looming collision.

The lane-following assistants use information provided by an environment-detection device. The environment-detection device typically includes an environment-detection device and a software-based detection device. Cameras mounted on the vehicle are frequently used as environment-detection devices, because the camera makes it possible to detect not only lane-delimiting elements having a three-dimensional structure, such as guardrails or curbs, for instance, but also traffic-lane markings painted on the roadway which do not significantly project above the road surface.

From the German patent DE 103 49 631 A1, a driver-assistance method is discussed in which the course of traffic lanes is estimated on the basis of information obtained from video sensor recordings as a function of weather conditions. In addition to the lane edge markings, it is possible to use additional information extracted from the images of the video sensor, i.e., the trajectory of one or more vehicle(s) driving ahead; the tracks of one or more vehicle(s) driving ahead during rain and snow; the trajectory of one or more oncoming vehicle(s); the course of lane edge boundaries such as guardrails, curbs etc. The data are combined in a lane-data estimation module and weighted, and, based on the estimated track course, a warning is output to the driver if straying from the lane appears to be imminent.

This has the disadvantage that the system is always based on the actual traffic lanes of the road. Consequently, the system must be provided with data pertaining to the course of the detected lane boundary markings and/or with information from a global positioning system and/or data of a navigation map. Although this may work for poor weather conditions, the system will no longer be usable if, for example, the road is covered by snow to such an extent that traffic lane markings are no longer detectable because they are buried under a snow layer, and no GPS data are available.

### SUMMARY OF THE INVENTION

It is an object of the exemplary embodiments and/or exemplary methods of the present invention to provide a driver-assistance method and a driver-assistance system which assists the driver in navigating snow-covered road sections.

The objective may be achieved by a driver-assistance method having the features described herein and by a driver-assistance system having the features described herein. Advantageous refinements of the exemplary embodiments and/or exemplary methods of the present invention are defined in the further descriptions herein.

Accordingly, an optical sensor in a driver-assistance method records an environment of a vehicle, and ruts are detected which are formed by the tracks of vehicles driving ahead, and a signal is output to the driver if the ruts are left. The signal output to the driver may consist of an acoustic signal, an optical signal or a haptic signal, in particular.

The varieties of tracks of vehicles driving ahead are referred to as ruts within the sense of the exemplary embodiments and/or exemplary methods of the present invention. That is to say, the focus in the exemplary embodiments and/or exemplary methods of the present invention lies on guiding the vehicle along tracks left by vehicles driving ahead.

It is especially advantageous that only information from the existing image material is used when detecting the ruts. As a result, the system is able to operate in reliable manner independently of GPS data. A potential trajectory through the snow-covered area is discernible in the image material, which, when left, triggers a warning to the driver, regardless of the course of possibly existing traffic lanes or traffic lane markings.

The detected ruts may include two tire tracks of a vehicle driving ahead and an untouched strip lying in-between.

According to one specific embodiment of the present invention, the tire tracks of vehicles driving ahead are detected. The tire tracks are produced by driving on the snow cover and form a dark contrast against the light background of the snow cover. If multiple vehicles are driving behind each other, then it is possible that accumulated tire tracks having low-contrast side regions are formed. The detected ruts may also include tire tracks having a dark imprint and lighter transitional zones toward the sides.

If tire tracks of multiple vehicles have been detected, the most traveled lane may be tracked, i.e., a plurality of vehicles is tracked at all times, which may be accomplished by determining the lane that has the most traffic. The most heavily traveled lane is detectable by a structure analysis, and the detection may include calculations via a monovalent differential operator and/or a gray scale evaluation. The structure analysis may include an edge count.

In one specific embodiment of the present invention, a tread of a tire impression in a tire track of a preceding vehicle is detected. The tread detection is able to take place via a structure analysis and includes calculations via a monovalent differential operator and/or via higher-value differential operations, and/or a detection of the tire tread pattern. The structure analysis may include an edge count.

The tire tracks of the preceding vehicle, which are separated from each other by approximately one vehicle width and shall be referred to as associated tire tracks in the following text, delimit a white center strip of snow. In one specific embodiment of the present invention, the strip delimited by the associated tire tracks of a preceding vehicle is detected. The detection of the most heavily traveled lane is able to be carried out via a structure analysis and includes calculations via a monovalent differential operator. The strip may also be measured for width by way of a pixel count. For navigation purposes, the strip is able to be used as virtual center line, i.e., as a reference line which is to run parallel to a center axis of the own vehicle.

If tire tracks are visible on the traffic lanes, then a white center strip may form in the middle, between a traffic lane and an associated oncoming traffic lane, the center strip being delimited by tracks of the traffic and the oncoming traffic. The white center strip delimits the ruts of the own vehicle on the left side and the ruts of the oncoming traffic on the right side, when viewed from the direction of the own vehicle. According to one specific embodiment of the present invention, the white center strip, delimited by the tracks of the oncoming traffic, is detected. The navigation may be accomplished on the basis of the position of the white center strip, by guiding the own vehicle past the white center strip on the right side. The ruts may be defined such that they run along the center strip, abutting it on the right.

In addition to detecting the ruts, tracking of the preceding vehicle may take place. According to one specific embodiment of the present invention, the vehicle driving ahead is tracked. Tracking of the vehicle driving ahead includes determining the position and the speed of the preceding vehicle in relation to the own vehicle, using successive digital images of the optical sensor. In the process, the understanding may advantageously be utilized that a tire track leads to the vehicle in front and that any movement of the preceding vehicle, in particular also an evasive maneuver in front of an obstacle, or cornering necessarily translates into tire tracks appearing behind the vehicle. The findings regarding the position and the movement of the preceding vehicle may supplement the knowledge of the ruts.

According to one specific development of the present invention, it is detected whether a road having a low snow load or a road having a high snow load is at hand. In the case of a road with a high snow load, which may be the tire tracks of the vehicles driving ahead are analyzed. An analysis of image data on the center strip lying between the traffic lanes may take place in addition, but it may also be taken into account at a lower weight. A search for tire tread patterns in the snow is able to take place, in particular on the road with the high snow load, which may require a structure analysis via higher-value differential operators. In case of a road with a low snow load, an approach via pixel numbers may be used and a search for the white center strips located between the traffic lanes may be conducted.

According to one specific embodiment, straying from the ruts is defined by the fact that wheels on both sides of the vehicle stray from the ruts by a minimum distance. That is to say, the signal for the driver is first output when the wheels on both sides have strayed from the ruts by a minimum distance. Straying from the ruts thus may also be described by the fact that none of the front wheels is situated in a rut or around a rut any longer. The defined distance may be between 0.5 m and 3 m, which may be between 1 m and 2 m. As an alternative, straying from the ruts may also be defined in that the distance between a center axis of the vehicle and a center line through a strip delimited by two associated tire tracks exceeds a defined distance, or drops below a distance from a center line of a center strip abutting on the left.

Furthermore, in accordance with the exemplary embodiments and/or exemplary methods of the present invention, a computer program is provided, according to which one of the methods described here is implemented when the computer program is run on a programmable computer device. The computer program, for instance, may be a module for implementing a driver-assistance system or a subsystem thereof in a vehicle, or an application for driver-assistance functions which is able to be executed on a smartphone. The computer program is able to be stored on a machine-readable storage medium, such as a permanent or rewritable storage medium or in an assignment to a computer device or on a removable CD-ROM or a USB stick. In addition or as an alternative, the computer program may be provided on a computer device, such as a server, for download, e.g., via a data network such as the Internet, or via a communication link such as a telephone line or a wireless connection.

In addition, according to the exemplary embodiments and/or exemplary methods of the present invention a driver-assistance system for executing one of the described methods is provided, which
has an optical sensor for recording a vehicle environment;
a component for detecting ruts on images of the optical sensor; and
a component for controlling a device for the output of a warning signal when straying from the ruts occurs.

The component for detecting objects on images of the optical sensor, for example, utilizes image information such as optical contrasts or 3D information obtained from image sequences or from stereoscopic cameras.

The driver-assistance system is linkable to a device which is able to detect a weather condition. The device for detecting the weather condition may include both an active sensor system, e.g., a temperature sensor and/or a device for measuring a position of the windshield wipers, and be suitable for receiving data regarding a current weather situation in the vicinity of the vehicle, via a communication link or a data network such as the Internet.

The driver-assistance system may be able to switch between two different modes, which are optimized for a road having a high snow load or for a road having a low snow load.

Additional exemplary embodiments and advantages of the present invention are described in greater detail below with reference to the drawing.

### BRIEF DESCRIPTION OF THE DRAWINGS

FIG. 1 shows a schematic representation of functional components of a driver-assistance system.

FIG. 2 shows an image from a front camera of a road with a heavy snow cover.

FIG. 3 shows an image from a front camera of a road with a light snow cover.

### DETAILED DESCRIPTION

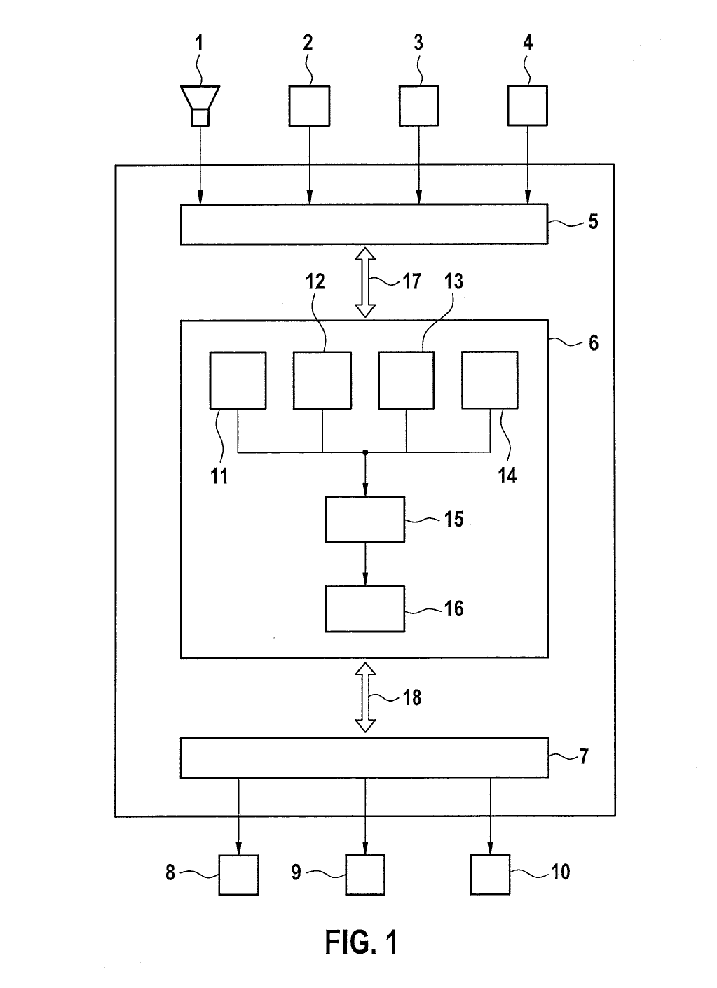

FIG. 1 shows a schematic representation of functional components of a driver-assistance system according to the present invention. The driver-assistance system is developed to output a signal to the driver as soon as the vehicle strays from a rut. For this purpose, the driver-assistance system includes an optical sensor 1, which in particular may be a front camera and/or a rear camera, and possibly a further sensor system such as a GPS receiver 2, a weather-condition detection device 3, and an own-data sensor system 4, whose signals are received in an input circuit 5. Input circuit 5 is linked to a bus system 17 for the exchange of data with a data processing device 6. Using another bus system 18, or the same bus system, data processing device 6 is connected to an output circuit 7, which is able to actuate output devices such as, in particular, acoustic devices 8, e.g., a signal tone generator and/or an onboard radio, optical devices 9 such as a display on a head-up display and/or a head-down display, and haptic devices 10, such as a vibrating steering wheel.

Data processing device 6 includes a rut detection module 11, in which in particular the data from optical sensor system 1 are processed further. Moreover, data processing device 6 may include a scenery detection module 12, a tracking module 13, and an own-data module 14. Rut detection module 11 may include calculation modules, which are used in a driver-assistance system to detect road tracks, e.g., optical contrast filters, structure analysis modules such as differential operators, etc. Scenery detection module 12 in particular processes the data of optical sensor 1 and weather condition detection device 3 as well as data of own-data device 7. Scenery detection module 12 is suitable for differentiating between a road having a high snow load and a road having a low snow load.

The movement of a preceding vehicle is tracked in tracking module 13. For this purpose, tracking module 13 processes data from image sensor 1 and own-data sensor system 4, in particular, and determines the position and the relative speed of the preceding vehicle. In own-data module 14, the own data from own-data sensor system 4, e.g., vehicle geometry data, tire position, steering angle, speed of the vehicle, and/or an absolute position of the vehicle, which it may receive from GPS receiver 2, are processed further in order to determine the position of the vehicle and an expected trajectory of the vehicle on that basis.

The data of rut detection module 11, of scenery detection module 12, tracking module 13, and own-data module 14 are combined in a situation evaluation module 15. In situation evaluation module 15, a comparison of the determined rut data and the projected course of the vehicle is carried out and used to estimate whether straying from the ruts has occurred and/or is to be expected at any moment. Situation evaluation module 15 is able to forward data to an output control module 16, which can control output circuit 7. Based on the determined situation, acoustical, optical and haptic warnings are output to the driver via output circuit 7, using external devices 8, 9, 10, and a steering intervention and/or a brake intervention may take place, if warranted.

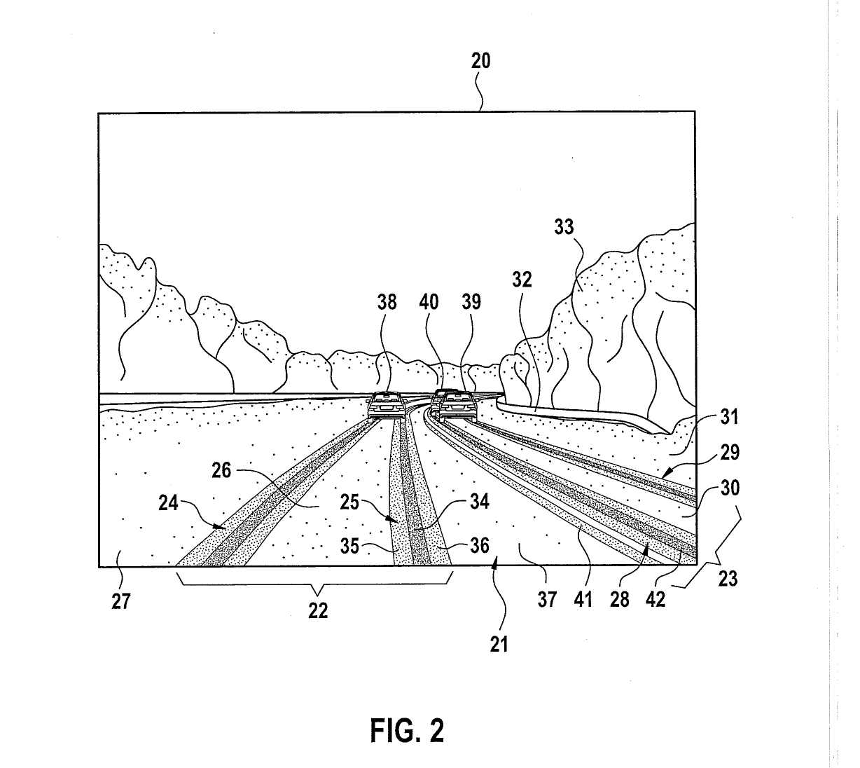

FIG. 2 shows an image 20, recorded by a front camera, showing a typical traffic situation on a road 21 having a high snow load. Shown are two adjacently located ruts 22, 23, which vehicles driving ahead have left in the snow. Left rut 22 lies in front of the own vehicle, which is located on a left traffic lane on road 21. Left rut 22 includes a left tire track 24 and a right tire track 25, which will also be referred to as two associated tire tracks 24, 25 in the following text, and which delimit a strip 26 lying in-between. Toward the left, the left tire track adjoins a white center strip 27 which is free of traffic. Right ruts 23 likewise include associated left and right tire tracks 28, 29, which delimit strip 30 lying in-between. Toward the right, right tire track 29 of right rut 23 adjoins a white outer strip 31, free of traffic, on which guardrails 32 are mounted and which abuts wooded terrain 33.

Tire tracks 24, 25, 28, 29 have been created by a multitude of vehicles driving ahead. With the aid of right tire track 25 of left rut 22, it is shown by way of example that it has one or more most heavily traveled inner region(s) 34, which is/are characterized by being especially dark. Adjoining are outer regions 35, 36, which show up somewhat lighter. The delimitation of inner region 34 from outer region 35, 36 may take place via a gradient process, by a differential operator, i.e., by determining a color contrast between the heavily traveled, less heavily traveled and undisturbed snow covers. In the same way, the delimitation of outer regions 35, 36 from undisturbed strip 26 between the associated tires of vehicles driving ahead and from undisturbed strip 37 between left and right ruts 22, 23 which may be via a gradient process by a differential operator. A width of inner region 34 and a width of outer regions 35, 36 may be determined via a pixel count.

Using left tire track 28 of right rut 23, it is shown by way of example that individual tire tracks may be present, in this case, a single tire track 41 on the left side, adjacent to a heavily traveled section 42. Rut detection module 11 detects single track 41 and the position of heavily traveled section 42. The position of rut 23 may be determined in relation to heavily traveled section 42.

On the right side, left ruts 22 may be defined by inner region 34 of right tire track 25. As an alternative, it may also be defined by the position of a darkest point of right tire tracks 25. It may also be defined by the position of a center point of inner 34, or inner 34 and outer 35, 36 regions of the tire track. In addition, it is possible to combine and suitably weight a plurality of said calculations and use them to determine the characteristic of rut 22. Rut 22 is determined in analogous manner in relation to left tire track 25. Situation evaluation module 15 ascertains whether the left-side front tire of the own vehicle has strayed from the left rut on the left side by a defined distance, e.g., 0.5 m to 2 m, especially 1 m, and whether the right front tire of the own vehicle has strayed from the left rut on the right side by a defined distance, e.g., 0.5 m to 2 m, in particular 1 m, and forwards the data to output control module 16 if both conditions are satisfied.

As an alternative or in addition, left rut 22 may be determined using the extension of strip 26 lying between associated tire tracks 24, 25. In so doing, situation evaluation module 15 determines whether the position of the vehicle axis in relation to a center point of strip 26 lying in-between has exceeded a defined distance, e.g., 0.5 m to 2 m, in particular 1 m, and forwards the data to output control module 16 if the condition is satisfied.

Also shown are vehicles 38, 39, 40 driving ahead. Using tracking module 13, vehicles 38, 39, 40 driving ahead are tracked and their distances in relation to the own vehicle, and their relative speed in relation to the own vehicle are calculated. In so doing, it is determined, in particular, which vehicle is located in the same rut as the own vehicle. Tracking of preceding vehicle 38 located in the same rut as the own vehicle may advantageously supplement the driver-assistance method described, for instance along road sections where no ruts are detectable, such as under bridges or in other snow-protected sections.

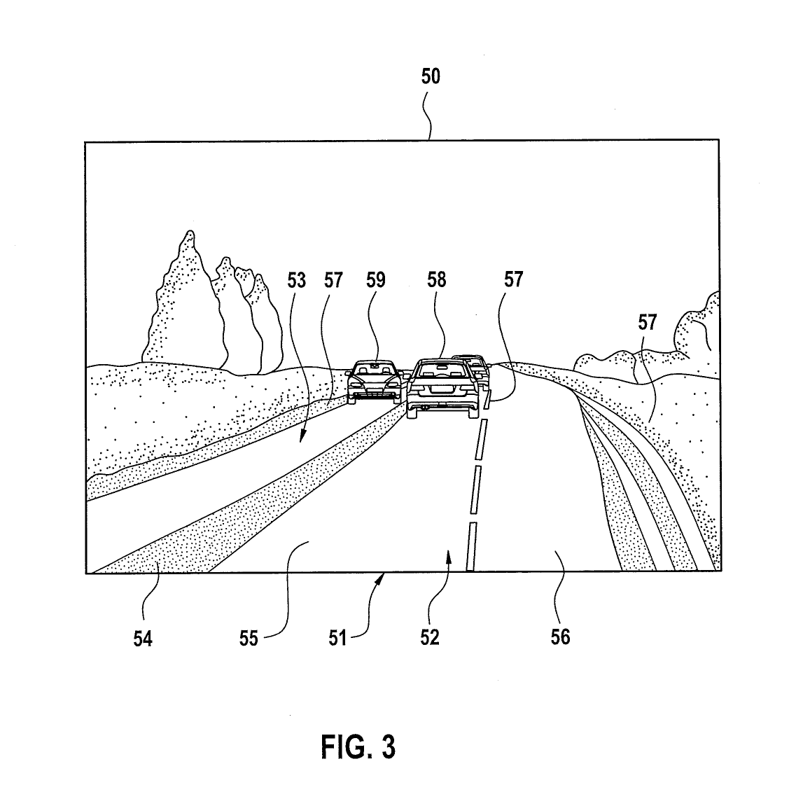

FIG. 3 shows an image 50 recorded by a front camera, showing a typical traffic situation on a road 51 having a low snow load. Shown are two adjacently lying ruts 52, 53, which had been left in the snow by preceding vehicles of traffic 58 and by vehicles of oncoming traffic 59. A right rut 52 lies in front of the own vehicle, which is located on road 51. No individual tire tracks are discernible in the right rut. Toward the left, right rut 52 abuts an untraveled white center strip 54, which delimits left rut 53 on the right side when viewed from the direction of the own vehicle. In other words, a white center strip 54 lies between right rut 52 and left rut 53. Right rut 52 includes a left track 55 and a right track 56, which are delimited from each other by traffic lane markings 57. Toward the right, right track 56 of right rut 52 abuts an untraveled white outer strip 57. The structures, especially the contours of the structures, are detected by rut detection module 11, as described with reference to FIG. 2. The width of center strip 54 is defined also by the position of the tracks of oncoming traffic 59.

In the case of a road 51 having a low snow load, a rut-straying warning is generated if right rut 52 has been left, which, for instance, may be defined by the fact that center strip 54 or outer strip 57 has been crossed by a defined distance such as 0.5 m to 2 m, in particular 1 m. In addition, the conventional lane keeping assistant may be active, which outputs a signal when the lanes are left.

What is claimed is:

1. A method for providing driver-assistance, the method comprising:
recording, via an optical sensor, an environment of a vehicle, and a rut created by tracks of vehicles so as to provide acquired data;
detecting a driving ahead based on the acquired data; and
outputting a signal to the driver when the vehicle leaves the rut.

2. The method of claim 1, wherein tire tracks of preceding vehicles are detected.

3. The method of claim 2, wherein a tread of a tire impression in a tire track of a vehicle driving ahead is detected.

4. The method of claim 1, wherein a strip delimited by associated tire tracks of vehicles driving ahead is detected.

5. A driver-assistance system, comprising:
a detection arrangement to detect a strip, which is delimited by tracks of traffic and oncoming traffic.

6. The method of claim 1, wherein a vehicle driving ahead is tracked.

7. The method of claim 1, wherein it is detected whether a road having a high snow load or a road having a low snow load is involved.

8. The method of claim 1, wherein straying from the rut is characterized by the wheels on both sides of the vehicle stray from the rut by a minimum distance.

9. A computer readable medium having a computer program, which is executable by a processor, comprising:
a program code arrangement having program code for providing driver-assistance, by performing the following:
recording, via an optical sensor, an environment of a vehicle, and a rut created by tracks of vehicles so as to provide acquired data;
detecting a driving ahead based on the acquired data; and
outputting a signal to the driver when the vehicle leaves the rut.

10. A driver-assistance system, comprising:
an optical sensor to record a vehicle environment;
a detecting arrangement to detect ruts on images from the optical sensor; and
an output arrangement to output a warning signal when a vehicle leaves the rut.
